(19) United States
(12) Patent Application Publication
(10) Pub. No.: US 2011/0167405 A1
(43) Pub. Date: Jul. 7, 2011

(54) APPLICATION BUILDING SYSTEM, METHOD AND COMPUTER-READABLE MEDIUM

(75) Inventor: Seung Ki MIN, Suwon-si (KR)

(73) Assignee: Samsung Electronics Co., Ltd., Suwon-si (KR)

(21) Appl. No.: 12/984,135

(22) Filed: Jan. 4, 2011

(30) Foreign Application Priority Data
Jan. 6, 2010 (KR) 10-2010-0000685

(51) Int. Cl. G06F 9/44

(52) U.S. Cl. 717/107

(57) ABSTRACT

An application building system includes a computer having a component container to download components from a server and to store the components, and the computer having a client to download the components from the component container, to load the downloaded components into a program, and to build the program.

The components having various functions may be reused when building an application and are prepared in advance and stored in the server. Program development capability of the application may be maximized by dynamically using the component container, and development time may be shortened.

### CROSS-REFERENCE TO RELATED APPLICATIONS

This application claims the benefit of Korean Patent Application No. 10-2010-0000685, filed on Jan. 6, 2010 in the Korean Intellectual Property Office, the disclosure of which is incorporated herein by reference.

### BACKGROUND

1. Field

Example embodiments relate to a component-based dynamic application building system, method and computer-readable medium building a new application by reusing binary code type components developed in advance.

2. Description of the Related Art

As society has rapidly developed, the number of mobile communication terminals, personal computers and service robots to facilitate human life has increased. Each mobile communication terminal, personal computer and service robot includes a plurality of applications to perform specific operations.

As the Internet has developed and the era of ubiquitous computing has arrived, various new applications are required. In addition, the necessity of upgrading existing applications has increased.

Such applications are individually designed and developed and are shared between developers by sharing an application's source code. However, it is difficult for developers separated geographically to share components developed in advance. Accordingly, it is difficult to reuse components in an application to be developed. In addition, since the components developed in advance are not consistently managed, there is a difficulty in cooperative development between developers. Therefore, considerable cost and time are consumed to develop an application.

In the late 1960s, the necessity of the reuse of components was suggested in order to overcome application development crisis. In the 1990s, component-based platforms, such as CORBA/CCM, COM+, Java/EJB and .NET, became the most widely used programming environments. Service-Oriented Architecture (SOA), which is a major topic of discussion in the IT industry, was advocated while asserting component reuse as an important merit in a broad sense.

However, if an application developer reuses components, although the components are reusable components, source code prepared by a third party needs to be found, analyzed, modified, and used. Accordingly, considerable operation time is required and thus development cost is significantly increased. Furthermore, it is difficult to find source code of components which are commercially available.

In addition, when an application developer reuses components, the developer executes associated components through one process in order to use the corresponding components. If the number of associated components is large, it is troublesome to individually execute all the associated components. In addition, executing the associated components through individual processes entails significant waste of computing resources.

When an application developer manually downloads or unloads components, it is difficult to dynamically manage the components using source code. Since the application developer copies the components and loads the components to an executed client, multiple clients may not share the components.

Accordingly, applications which reuse components have hardly developed.

### SUMMARY

Therefore, it is an aspect of the example embodiments to provide an application building system, method and computer-readable medium to maximize reuse of components using functions of components prepared in advance and stored in a server, to maximize development capability of an application using a component container, and to shorten an application development time.

The foregoing and/or other aspects are achieved by providing an application building system including a computer, including a component container to download components from a server and to store the components and the computer including at least one client to download the components from the component container, to load the downloaded components into a program, and to build the program.

The client may download the components from the component container and load the components to the program, when the program is executed.

The application building system may further include a component ID list unit having an ID list of components to be loaded into the client.

The component container may check the component ID list stored in the component ID list unit and unload unused components.

Each of the components may include at least one module and the module may have a function.

The application building system may further include a storage unit to store a plurality of components.

The component container may download the components from the storage unit corresponding to a request of the client.

Each of the components may be a binary executable file.

The at least one client is a plurality of clients and the plurality of clients may shares the components of the component container.

The application building system may further include a plurality of component ID list units to respectively store ID lists of the components to be loaded to the plurality of clients, and the component container may unload unused components based on the component IDs stored in the plurality of component ID list units.

The foregoing and/or other aspects are achieved by providing an application building system including a server to store a plurality of components and a terminal including a component container to store components transmitted from the server, and a client to make a request for at least one component to the server, to download the at least one component from the component container and to load the downloaded at least one component into a program.

The application building system may further include a storage unit to store the at least one component transmitted from the server.

The terminal and the server may communicate.

The client may include an interface to communicate with the server.

The component container may check unused components and unload the unused components.

The foregoing and/or other aspects are achieved by providing an application building method including: transmitting a request, by a processor, for components to a server, downloading, by the processor, the components from the server and storing the components in a component container and downloading, by the processor, the components from the component container and loading the components into a program of a client.

The transmitting of the request for the components to the server may include communicating with the server through an interface included in the client.

The downloading of the components from the component container may be performed based on a component downloading command loaded into the program of the client in advance.

The loading of the components to the program of the client may include sharing the components stored in the component container between a plurality of clients.

The application building method may further include checking ID lists of components to be loaded to the plurality of clients, and deleting unused components from the components stored in the component container.

Each of the components may be a binary executable file.

The downloading of the components from the component container may include storing the components transmitted from the server in a storage unit, and downloading the components from the storage unit and storing the components in the component container.

According to example embodiments, the reuse of the components may be maximized using the functions of the components prepared in advance and stored in the server, when building an application. Program development capability of the application may be maximized by dynamically using the component container, and thus development time may be decreased.

The client may operate with minimum code necessary for execution of a program and performs the other operations using the components stored in the component container. The size of the client may be decreased.

According to example embodiments, the component container may be shared between the plurality of clients on the same application building system to reduce waste of resources. The number of times the components are used by the plurality of clients may be checked and the components stored in the component container may be actively unloaded according to the number of times the components are used.

The client adds desired components to the component ID list without recompiling to manage the list of components to be used, and the desired components may be easily downloaded based on the component ID list.

According to another aspect of one or more embodiments, there is provided at least one non-transitory computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram showing an application building system according to example embodiments;

FIG. 2 is a block diagram showing a component database of a server provided in an application building system according to example embodiments of the present invention;

FIG. 3 is a diagram showing the configuration of a component in an application building system according to example embodiments in detail;

FIG. 4 is a flowchart illustrating an application building method according to example embodiments;

FIG. 5 is a diagram showing downloading of a component in an application building method according to example embodiments;

FIG. 6 is a diagram showing building of a program in an application building method according to example embodiments;

FIG. 7 is a block diagram showing an application building system according to example embodiments; and

FIG. 8 is a diagram showing downloading and unloading of a component in the application building system according to example embodiments.

### DETAILED DESCRIPTION

Reference will now be made in detail to embodiments, examples of which are illustrated in the accompanying drawings.

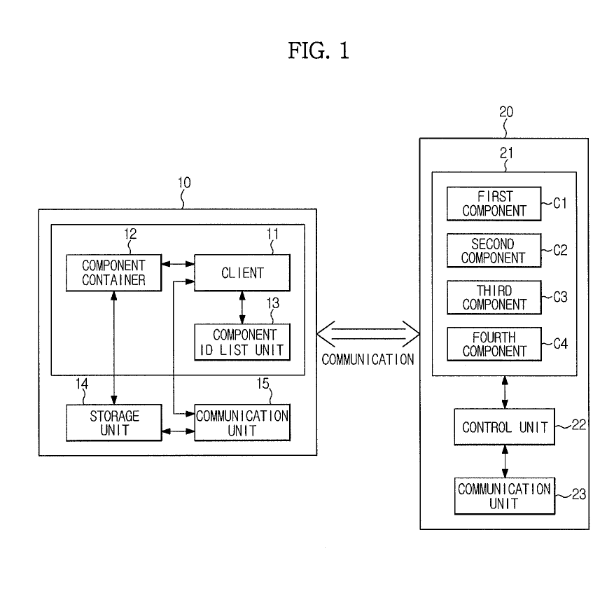

FIG. 1 is a block diagram showing an application building system according to example embodiments. The application building system may include a terminal 10 and a server 20.

The terminal 10 may download components from a server 20 and build an application using the downloaded components. The terminal 10 may include a client 11, a component container 12, a component ID list unit 13, a storage unit 14, and a communication unit 15.

The terminal 10 may include a mobile communication terminal, a personal computer, a service robot, or the like, which may be executed by building an application.

The application may be a program designed to perform a predetermined operation and examples thereof include a word processor, a web browser, an image editing program, a communication program, a robot driving program and the like.

The client 11 may include a program to perform at least one of a plurality of operations determined by the application, and include a set of commands to perform the operations.

Regarding a robot, a robot driving program i.e. application to drive the robot is built. The robot driving program may include a program to recognize a user's face, a program to recognize user's voice, a program to control walking, and the like. Each of the programs to drive the robot may become one client.

The client 11 may check components to be loaded when building a program, compare IDs of the components to be loaded with component IDs of the component ID list unit 14, and detect component IDs which are not present in the component ID list unit 13, from the IDs of the components to be loaded.

The client 11 may detect components which have never been downloaded from the server 20.

The client 11 may make a request for the components having the IDs which are not present in the component ID list unit 13 to the server 20 to download the requested components to the component container 12.

In the client 11, since component downloading and unloading commands may be loaded in the program in advance, downloading and unloading operations may be dynamically performed. Accordingly, the components may be dynamically loaded.

The client 11 may add the IDs of the components downloaded to the component container 12 to the component ID list unit 13 when downloading the components from the server 20 and the components are not downloaded from the server 20 but from the component container 12 when the components are needed.

If the IDs of the components to be loaded to the client 11 are present in the component ID list unit 13, it may be determined that the components have already been downloaded from the server 20. Thus, the components may not be downloaded.

The client 11 may easily download the components to be loaded from the component container 12 without compiling and may dynamically download the components.

The client 11 may receive and load the components from the component container 12 when executing the program. When the loading of the components is completed, the program may be executed.

The client 11 may include an Application Programming Interface (API) to officially request an operation of another program or to perform communication.

The client 11 may determine whether the components stored in the component ID list unit 13 are used, delete the IDs of unused components from the component ID list unit 13 if it is determined that unused components are present, and unload the components from the component container 12.

The client 11 may operate with a minimum code necessary for execution of a program and perform the other operations using the components stored in the component container 12.

Accordingly, since the client 11 may use functions in modules of components prepared in advance when executing the program, program development time may be shortened and the overall size of the program may be decreased.

The component container 12 may download the components to be loaded into the program of the client 11 from the storage unit 14 and store the components therein. The stored components may be downloaded to the client 11 according to the request of the client 11 when executing the program of the client 11.

The components may be stored as a binary executable file, and each of the components may have at least one module. A function to perform at least one operation may be recorded in the module.

The component container 12 may collect independent modules to form a component, and store the component. The component container 12 may perform communication between modules.

The component container 12 may check the component Ds stored in the component ID list unit 13, detect the unused components, and unload the unused components.

The component container 12 may freely download the components from the storage unit 14 and freely unload the unused components.

Program development capability of an application may be maximized by dynamically using the component container 12 and development time may be shortened.

If the client 11 makes a request for the components, the component container 12 may only download components having IDs which are not stored in the component ID list unit 13 of the requested components to the client 11.

The component ID list unit 13 may store the IDs of the components to be loaded into the client 11. The component ID list unit 13 may delete the IDs of the unused components from the client 11 according to an instruction of the client 11.

The component ID list unit 13 may always modify the ID list of the components requested by the client 11.

The client 11 may download the components from the component container 12 according to an order of the component ID list of the component ID list unit 13, the component container 12 may download the components from the storage unit 14 according to an order of the component ID list of the component ID list unit 13, and the storage unit 14 may download the components from the server 20 according to an order of the component ID list of the component ID list unit 13.

The storage unit 14 may download the components corresponding to the request of the client 11 from the server 20 and store the components therein.

The communication unit 15 may perform wired/wireless communication with a communication unit 23 of the server 20, transmit a component request signal to the server 20, download the components from the server 20, and transmit the components to the storage unit 14.

The server 20 may store a plurality of components, and transmit components corresponding to the request of the terminal 10 to the terminal 10. The server 20 may include a component database 21, a controller 22 and the communication unit 23.

The component database 21 may store the plurality of components C1, C2, C3 and C4.

Each of the plurality of components C1, C2, C3 and C4 may have at least one module.

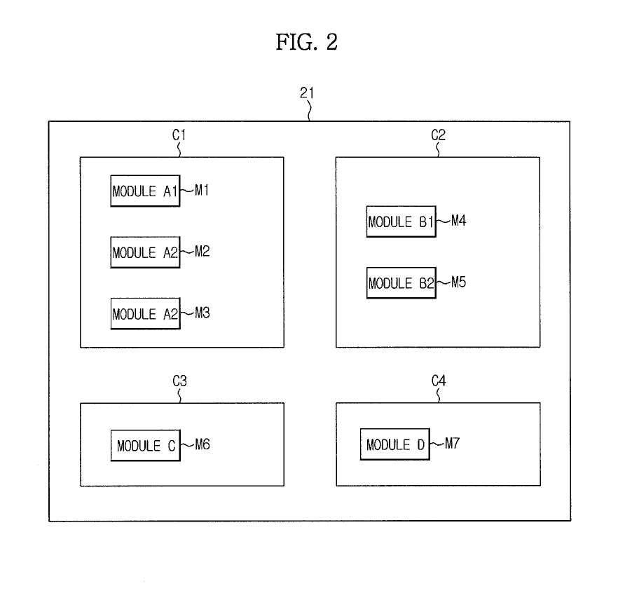

As shown in FIG. 2, the first component C1 may include a module A1 (M1), a module A2 (M2), and a module A3 (M3), the second component C2 may include a module B1 (M4) and a module B2 (M5), the third component C3 may include a module C (M6), and the fourth component C3 may include a module D (M7).

The modules included in the components C1, C2, C3 and C4 may include independent modules equal or similar operations A, B, C and D.

At least one function to perform a predetermined operation may be recorded in each of the modules.

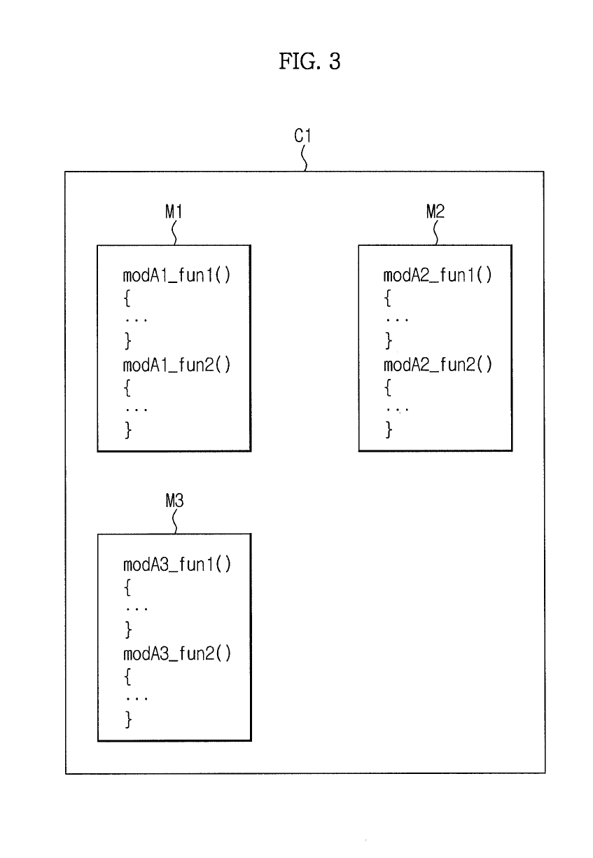

As shown in FIG. 3, regarding the module A1 (M1), the module A2 (M2) and the module A3 (M3) of the first component C1, an A1 function 1 (modA1_fun1( )) to perform a first operation of A1 and an A1 function 2 (modA1_fun2( )) to perform a second operation of A1 may be recorded in the module A1 (M1), an A2 function 1 (modA2_fun1( )) to perform a first operation of A2 and an A2 function 2 (modA2_fun( )) to perform a second operation of A2 may be recorded in the module A2 (M2), and an A3 function 1 (modA3_fun1( )) to perform a first operation of A3 and an A3 function 2 (modA3_fun2( )) to perform a second operation of A3 may be recorded in the module A3 (M3).

When the terminal 10 transmits the component request signal, the control unit 22 may search for and extract the components from the component database 21 and control the communication unit 23 so that the extracted components are transmitted to the terminal 10.

The communication unit 23 may perform wired/wireless communication with the communication unit 15 of the terminal 10, receive the component request signal from the communication unit 15 of the terminal 10, transmit the component request signal to the control unit 22, and transmit the components to the communication unit 15 of the terminal 10 according to an instruction of the control unit 22.

The program to perform at least one operation may be developed in the component units to be stored in the server 20. Components that have already been developed may be shared between developers through the server 20 to support cooperative development between geographically separated developers and to suitably load the components to the program without modification.

In addition, the reuse of the components may be maximized using the server 20 and a program development time of an application may be significantly shortened.

The reuse of the component may indicate that binary code components which are already developed and compiled are loaded into a new program to be reused, without modifying source code.

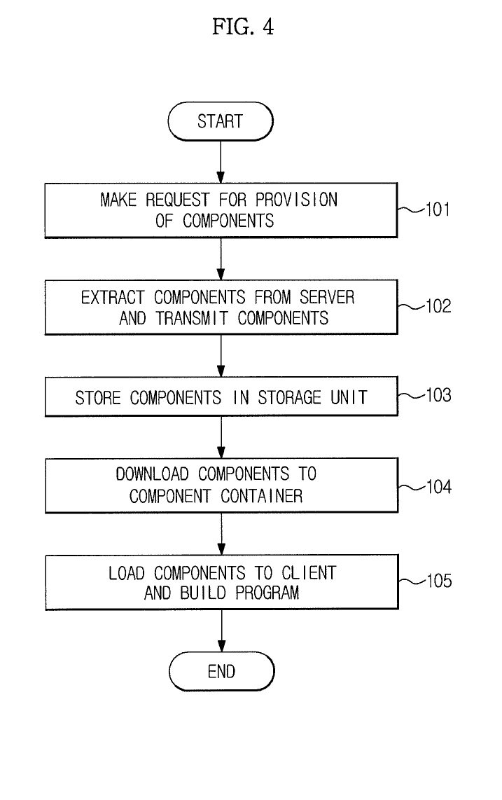

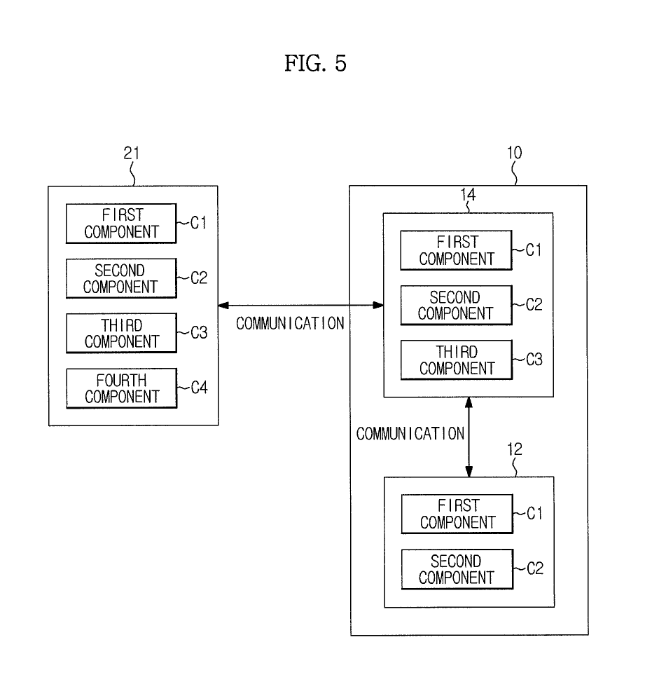

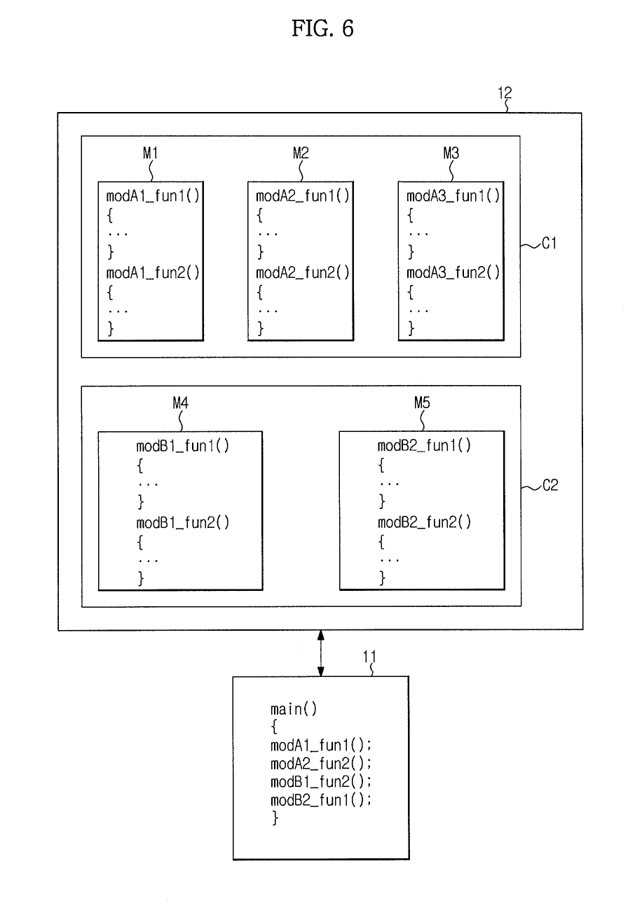

FIG. 4 is a flowchart illustrating an application building method according to the example embodiments, which will be described with reference to FIGS. 5 and 6.

First, the client 11 may build the program using components to perform at least one operation.

The components may include commands or functions to fetch the program to perform a predetermined operation from the component container 12, and the components may be a binary executable file.

The client 11 may check components to be loaded when building the program, compare the IDs of the components to be loaded with the component IDs of the component ID list unit 13, and detect the IDs of the components which are not present in the component ID list unit 13 of the IDs of the components to be loaded.

If the IDs of the components to be loaded to the client 11 are already present in the component ID list unit 13, it may be determined that the components are already downloaded from the server 20 and the components are not downloaded. In addition, the components which have never been downloaded from the server 20 are detected and may be downloaded.

The client 11 may make a request for the components having the IDs, which are not present in the component ID list unit 13, to the server 20 (101).

The client 11 may include an Application Programming Interface (API) to officially request an operation of the program of the component container 12 or the server 20 or to perform communication.

When the client 11 of the terminal 10 transmits the component request signal, the server 20 may search the component database 21, extract the components corresponding to the request of the terminal 10, and transmit the extracted components to the storage unit 14 of the terminal (102).

Next, the storage unit 14 of the terminal 10 may download the components corresponding to the request of the client 11 from the server 20 and store the components (103).

Next, the component container 12 may search the storage unit 14 for the components to be used by the client 11 and download the retrieved components (104).

More particularly, as shown in FIG. 5, if the client 11 transmits the signal for requesting the first, second and third components C1, C2 and C3, the server 20 may search the component database 21, extract the first, second and third components C1, C2 and C3 corresponding to the request of the terminal 10, and transmit the components to the storage unit 14 of the terminal 10.

Next, the component container 12 may search the storage unit 14 and download the first, second and third components C1, C2 and C3 to be loaded to the client.

If the components initially stored in the storage unit 14 are the components initially requested by the client 11, all the components may be transmitted to the component container 12.

The storage unit 14 may continuously store the components C1, C2 and C3 transmitted from the server 20. When the program of the client is executed, some components C1 and C2 corresponding to the request of the component container 12 may be downloaded to the component container 12.

The components stored in the component container 12 may be stored as a binary executable file, and each of the components may have at least one module. The function to perform at least one operation may be recorded in the module.

The components may be downloaded according to the order of the component ID list of the component ID list unit 13.

Next, the client 11 may download the components from the component container 12 and load the components to build the program (105). When the building of the program is completed, the program may be executed.

Since component downloading and unloading commands are loaded in the program of the client 11 in advance, the downloading and unloading operations may be performed dynamically. Accordingly, the components may be loaded dynamically.

More particularly, as shown in FIG. 6, if the first and second components C1 and C2 are stored in the component container 12, the first and second components C1 and C2 of the component container 12 may include a module A1 (M1), a module A2 (M2), a module A3 (M3), a module B1 (M4) and a module B2 (M5).

At least one function to perform a predetermined operation may be recorded in each of the modules. The module A1 (M1) may have an A1 function 1 (modA1_fun1( )) to perform a first operation of A1 and an A1 function 2 (modA1_fun2( )) to perform a second operation of A1, the module A2 (M2) may have an A2 function 1 (modA2_fun1( )) to perform a first operation of A2 and an A2 function 2 (modA2_fun( )) to perform a second operation of A2, and the module A3 (M3) may have an A3 function 1 (modA3_fun1( )) to perform a first operation of A3 and an A3 function 2 (modA3_fun2( )) to perform a second operation of A3.

The module B1 (M4) may have a B1 function 1 (modB1_fun1( )) to perform a first operation of B1 and a B1 function 2 (modB1_fun2( )) to perform a second operation of B1, and the module B2 (M2) may have a B2 function 1 (modB2_fun1( )) to perform a first function of B2 and a B2 function 2 (modeB2_fun2( )) to perform a second function of B2.

If the A1 function 1 (modA1_fun1( )), the A2 function 2 (modA2_fun2( )), the B1 function 2 (modB1_fun2( )) and the B2 function 1 (modB2_fun1( )) are loaded, the client 11 may receive the first component C1 and the second component C2 including the A1 function 1 (modA1_fun1( )), the A2 function 2 (modA2_fun2( )), the B1 function 2 (modB1_fun2( )) and the B2 function 1 (modB2_fun1( )) from the component container 12, extract the A1 function 1 (modA1_fun1( )), the A2 function 2 (modA2_fun2( )), the B1 function 2 (modB1_fun2( )) and the B2 function 1 (modB2_fun1( )) from the first component C1 and the second component C2, and load them, thereby building the program.

The client 11 may execute the program when the loading of the components is completed.

The client 11 may add the IDs of the downloaded components to the component ID list unit 13 when downloading the components from the component container 12. Therefore, when the components are required in the future, the components need not be downloaded from the server 20 but rather are directly downloaded from the component container 12.

The client 11 may easily download the components to be loaded from the component container 12 without compiling and dynamically download the components.

The client 11 may operate with minimum amount of code necessary for execution of a program and perform the other operations using the components stored in the component container 12.

Accordingly, since the client 11 may use functions in the modules of the components prepared in advance when executing the program, program development time may be shortened and the overall size of the program may be decreased.

The program to perform at least one operation may be developed in the component units to be stored in the server 20. Components that have already been developed may be shared between developers through the server 20 to support cooperative development between geographically separated developers and to suitably load the components to the program without modification.

In addition, the reuse of the components may be maximized using the server 20 and thus program development time of an application may be significantly shortened.

The client 11 may determine whether the components stored in the component ID list unit 13 may be used, and delete the IDs of the unused components from the component ID list unit 13 if it is determined that unused components are present.

The component container 12 may check the IDs of the components stored in the component ID list unit 13, detect the unused components, and unload the unused components.

The component container 12 may freely download the components from the storage unit 14 and freely unload the unused components.

Program development capability of an application may be maximized by dynamically using the component container 12, and development time may be shortened.

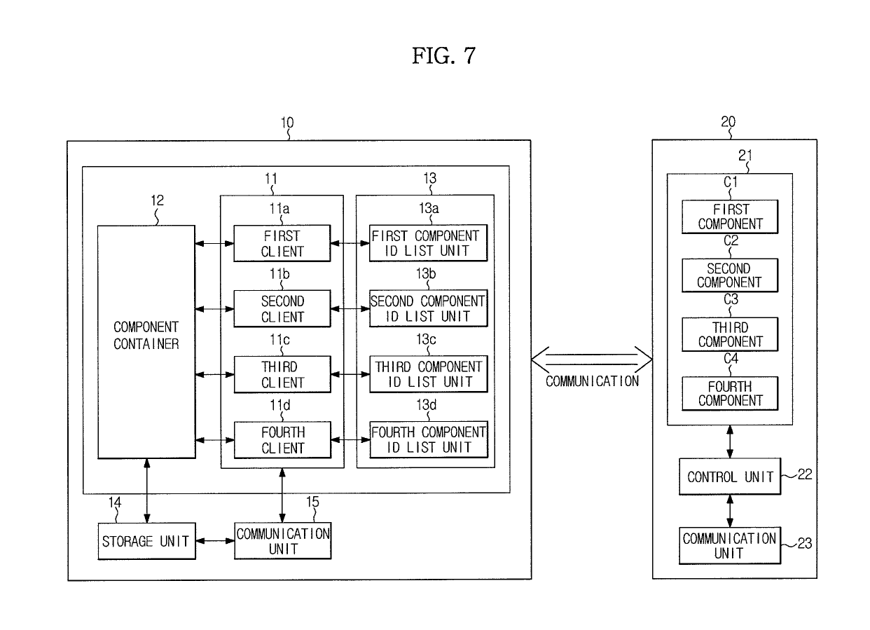

FIG. 7 is a block diagram showing an application building system according to example embodiments. The application building system may include a terminal 10 and a server 20.

The terminal 10 may download components from the server 20 and build an application using the downloaded components. The terminal 10 may include a plurality of clients 11, a component container 12, a plurality of component ID list units 13, a storage unit 14 and a communication unit 15.

The plurality of clients 11 (11a, 11b, 11c and 11d) may include a plurality of programs to perform at least one of a plurality of operations set in the application. Each of the programs of the plurality of clients 11 may include a set of commands to perform predetermined operations.

The plurality of component ID list units 13 (13a, 13b, 13c and 13d) corresponding to the plurality of clients 11 (11a, 11b, 11c and 11d) may be provided, and store and manage the IDs of components to be loaded when building respective programs.

The plurality of clients 11 (11a, 11b, 11c and 11d) may check the components to be loaded to the respective programs when building the programs, respectively compare the IDs of the components to be loaded with the component IDs of the component ID list units 13 (13a, 13b, 13c and 13d), and detect component IDs which are not present in the component ID list units 13 from the IDs of the components to be loaded.

The clients 11 (11a, 11b, 11c and 11d) may compare the respective component IDs with the component IDs of the component ID list units 13 (13a, 13b, 13c and 13d) corresponding to the other clients and it may be determined whether the components to be loaded to the respective programs are used by the other clients.

The clients 11 (11a, 11b, 11c and 11d) may detect the components which have never been downloaded from the server 20.

The plurality of clients 11 (11a, 11b, 11c and 11d) may make a request for the components having the IDs which are not present in the component ID list units 13 (13a, 13b, 13c and 13d) to the server 20.

Since component downloading and unloading commands are loaded in the programs of the clients 11 (11a, 11b, 11c and 11d) in advance the downloading and unloading operations may be performed dynamically. Accordingly, the components may be loaded dynamically.

The clients 11 (11a, 11b, 11c and 11d) may add the IDs of the downloaded components to the component ID list units 13 (13a, 13b, 13c and 13d) respectively corresponding thereto when downloading the components from the component container 12, so that the components are not downloaded from the server 20 but rather are downloaded from the component container 12 if the components are required in the future.

In addition, if the IDs of the components to be loaded to the respective clients 11 (11a, 11b, 11c and 11d) are present in the component ID list units 13 (13a, 13b, 13c and 13d), it may be determined that the components are already downloaded from the server 20 and the components need not be downloaded.

The clients 11 (11a, 11b, 11c and 11d) may share the component container 12 to easily and dynamically download the components to be loaded without compiling.

The clients 11 (11a, 11b, 11c and 11) may download the components to be loaded from the component container 12 and load the components when executing the programs. When the loading of the components is completed, the programs may be executed.

Each of the clients 11 (11a, 11b, 11c and 11d) may include an API to officially request an operation of another program or to perform communication.

The clients 11 (11a, 11b, 11c and 11d) may determine whether the components respectively stored in the component ID list units 13 corresponding thereto are used and delete the IDs of the unused components from the component ID list units 13 if it is determined that unused components are present.

The plurality of clients 11 (11a, 11b, 11c and 11d) may operate with a minimum amount of code necessary for execution of respective programs and perform the other operations using the components stored in the component container 12.

Accordingly, since the clients 11 (11a, 11b, 11c and 11d) use functions in modules of components which are prepared in advance when executing the programs, program development time may be shortened and the overall size of the program may be decreased.

The component container 12 may download the components to be loaded to the programs of the clients 11 (11a, 11b, 11c and 11d) from the storage unit 14 and store the components therein. The clients 11 (11a, 11b, 11c and 11d) may download the components from the component container 12 when executing the programs of the clients 11.

The components may be stored as a binary executable file and each of the components may have at least one module. A function to perform at least one operation may be recorded in the module.

The component container 12 may collect independent modules to form a component and store the component. The component container 12 may perform communication between modules.

The component container 12 may check the component IDs stored in the component ID list units 13 (13a, 13b, 13c and 13d).

When any one component is transmitted to the plurality of clients, the component container 12 may increase the number of times of use of the component based upon the number of clients which use the component. The component container 12 may count the number of times of use of the stored components and unload unused components.

Since the number of times of use of the components stored in the component container 12 may be counted, the unused components may be unloaded. If the unloaded components are required in the future, the components may be downloaded from the storage unit 14.

The component container 12 may freely download the components from the storage unit 14 and freely unload the unused components.

Program development capability of an application may be maximized by dynamically using the component container 12, and development time may be shortened.

If the clients 11 make a request for components, the component container 12 may compare the IDs of the requested components with the component IDs stored in the component ID list units 13, and download only components having IDs which are not stored in the component ID list units 13.

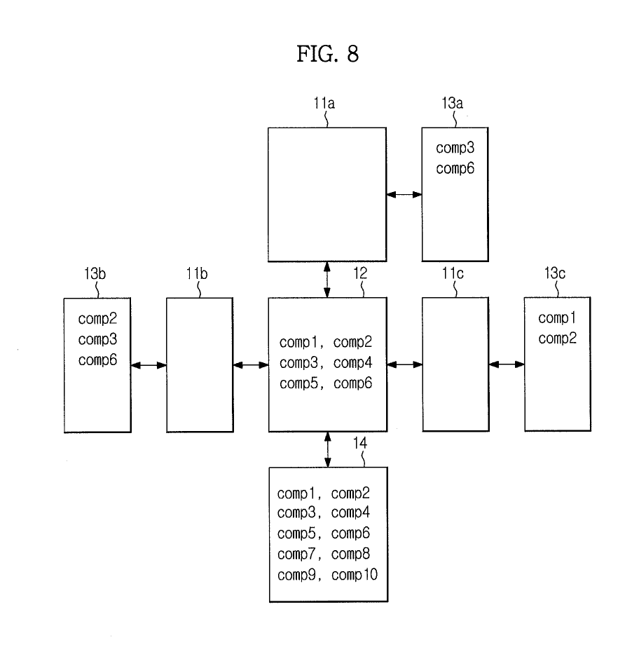

More particularly, as shown in FIG. 8, the storage unit 14 may download and store components having IDs of comp1 to comp10 from the server 20 and the component container 12 may download and store the components having IDs of comp1 to comp6 from the storage unit 14.

The IDs comp3 and comp6 of the components to be loaded to the program of the first client 11a may be stored in the first component ID list unit 13a, the IDs comp2, comp3 and comp6 of the components to be loaded to the program of the second client 11b may be stored in the second component ID list unit 13b, and the IDs comp1 and comp2 of the components to be loaded to the program of the third client 11c may be stored in the third component ID list unit 13c.

When the programs of the first to third clients 11a, 11b and 11c are executed, the clients 11a, 11b and 11c may download the components from the component container 12. The component container 12 may count the number of times the components have been used by the clients 11a, 11b and 11c.

As shown in FIG. 8, the component container 12 may count the number of times of use of the components stored therein. The number of times of use of the component having the ID of comp1 may be 1, the number of times of use of the component having the ID of comp2 may be two, the number of times of use of the component having the ID of comp3 may be two, the number of times of use of the component having the ID of comp4 may be 0, the number of times of use of the component having the ID of comp5 may be 0, and the number of times of use of the component having the ID of comp5 may be two.

The unused components having the IDs of comp4 and comp5 may be unloaded. If the components having the IDs of comp4 and comp5 are loaded in the future, the component container 12 may download the components having the IDs of comp4 and comp5 from the storage unit 14, and store and transmit the components to the client.

The component container 12 may check the ID list of the components stored in the first to third component ID list units 13a, 13b and 13c and unload unused components.

The component container 12 may be shared between the plurality of clients on the same terminal. The plurality of clients may share the components of the component container 12 on the same terminal to reduce waste of resources.

The plurality of component ID list units 13 (13a, 13b, 13c and 13d) may store the IDs of the components loaded to the clients 11 (11a, 11b, 11c and 11d) corresponding thereto. The plurality of component ID list units 13 (13a, 13b, 13c and 13d) may delete the IDs of the unused components according to the instruction of the clients 11 (11a, 11b, 11c and 11d).

The storage unit 14 may download the components corresponding to the request of the plurality of clients 11 (11a, 11b, 11c and 11d) from the server 20 and store the components.

The communication unit 15 may perform wired/wireless communication with the communication unit 23 of the server 20 to transmit the component request signal to the server 20, download the components from the server 20, and transmit the components to the storage unit 14.

The server 20 may store the plurality of components and transmit the components corresponding to the request of the plurality of clients 11 (11a, 11b, 11c and 11d) of the terminal 10 to the terminal 10. The server 20 may include a database unit 21, a control unit 22 and a communication unit 23.

The component database unit 21 may store the plurality of components C1, C2, C3 and C4. Each of the plurality of components C1, C2, C3 and C4 may have at least one module.

At this time, the module provided in each of the components C1, C2, C3 and C4 may include independent modules having equal or similar operations A, B, C and D. A function to perform a predetermined operation may be recorded in each of the modules.

When the terminal 10 transmits the component request signal, the control unit 22 may search for and extract the components from the component database 21 and cause the communication unit 23 to transmit the extracted components to the terminal 10.

The communication unit 23 may perform wired/wireless communication with the communication unit 15 of the terminal 10, receive the component request signal from the communication unit 15 of the terminal 10, transmit the signal to the control unit 22, and transmit the components to the communication unit 15 of the terminal 10 according to the instruction of the control unit 22.

A program to perform at least one operation may be developed in the component units and stored in the server 20 and the components that have already been developed may be shared between developers through the server 20 to support cooperative development between geographically separated developers and to suitably load the components to the program without modification.

In addition, the reuse of the components may be maximized using the server 20 and thus program development time of an application may be significantly shortened.

The above-described embodiments may be recorded in non-transitory computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although example embodiments have been shown and described, it should be appreciated by those skilled in the art that changes may be made in these embodiments without departing from the principles and spirit of the disclosure, the scope of which is defined in the claims and their equivalents.

What is claimed is:

1. An application building system, comprising:
a computer having a component container to download components from a server and to store the components; and
the computer having at least one client to download the components from the component container, to load the downloaded components into a program, and to build the program.

2. The application building system according to claim 1, wherein the client downloads the components from the component container and loads the components to the program, when the program is executed.

3. The application building system according to claim 1, further comprising a component ID list unit having an ID list of components to be loaded into the client.

4. The application building system according to claim 3, wherein the component container checks the component ID list stored in the component ID list unit and unloads unused components.

5. The application building system according to claim 1, wherein each of the components includes at least one module and the module has a function.

6. The application building system according to claim 1, further comprising a storage unit to store a plurality of components.

7. The application building system according to claim 6, wherein the component container downloads the components from the storage unit corresponding to a request of the client.

8. The application building system according to claim 1, wherein each of the components is a binary executable file.

9. The application building system according to claim 1, wherein the at least one client is a plurality of clients and the plurality of clients share the components of the component container.

10. The application building system according to claim 9, further comprising a plurality of component ID list units to respectively store ID lists of the components to be loaded to the plurality of clients,
wherein the component container unloads unused components based on the component IDs stored in the plurality of component ID list units.

11. An application building system, comprising:
a server to store a plurality of components; and
a terminal including a component container to store components transmitted from the server, and a client to make a request for at least one component from the server, to download the at least one component from the component container and to load the downloaded at least one components into a program.

12. The application building system according to claim 11, further comprising a storage unit to store the components transmitted from the server.

13. The application building system according to claim 11, wherein the terminal and the server communicate.

14. The application building system according to claim 11, wherein the client includes an interface to communicate with the server.

15. The application building system according to claim 1, wherein the component container checks unused components and unloads the unused components.

16. An application building method, comprising:
transmitting, by a processor, a request for components to a server;
downloading, by the processor, the components from the server and storing the components in a component container; and
downloading, by the processor, the components from the component container and loading the components into a program of a client.

17. The application building method according to claim 16, wherein the transmitting of the request for the components to the server includes:
communicating with the server through an interface included in the client.

18. The application building method according to claim 16, wherein the downloading of the components from the component container is performed based on a component downloading command loaded into the program of the client in advance.

19. The application building method according to claim 16, wherein the loading of the components into the program of the client includes sharing the components stored in the component container between a plurality of clients.

20. The application building method according to claim 19, further comprising:
checking ID lists of components to be loaded to the plurality of clients; and
deleting unused components from the components stored in the component container.

21. The application building method according to claim 16, wherein each of the components is a binary executable file.

22. The application building method according to claim 16, wherein the downloading of the components from the component container includes:
storing the components transmitted from the server in a storage unit; and
downloading the components from the storage unit and storing the components in the component container.

23. At least one non-transitory computer readable medium comprising computer readable instructions that control at least one processor to implement the method of claim 16.
